(19) United States
(12) Patent Application Publication
(10) Pub. No.: US 2017/0366208 A1
(43) Pub. Date: Dec. 21, 2017

(54) Ultrawideband Co-polarized Simultaneous Transmit and Receive Aperture (STAR)

(71) Applicant: THE REGENTS OF THE UNIVERSITY OF COLORADO, A BODY CORPORATE, DENVER, CO (US)

(72) Inventors: Dejan S. Filipovic, Lafayette, CO (US); Mohamed Ali Elmansouri, Boulder, CO (US); Ehab Abdalla Etellisi, Denver, CO (US)

(21) Appl. No.: 15/626,004

(22) Filed: Jun. 16, 2017

Related U.S. Application Data
(60) Provisional application No. 62/350,914, filed on Jun. 16, 2016.

(51) Int. Cl. H04B 1/04; H01Q 21/20; H01P 1/213; G01S 7/02; G01S 13/90; G01S 13/34; H01Q 21/28; H01Q 9/32

(52) U.S. Cl. CPC H04B 1/0458; H01Q 21/28; H01Q 21/205; H01Q 9/32; G01S 7/023; G01S 13/9023; G01S 13/34; H01P 1/213

(57) ABSTRACT

In various implementations, designs of relatively simple ultra-wideband STAR front-end systems are provided. For example, such systems may include implementations utilizing a plurality of antenna arms in which a first portion of the arms is configured to transmit and a second portion of the arms is configured to receive. In one implementation, for example, a co-channel simultaneous transmit and receive (STAR) monostatic aperture configuration includes a single-polarized multi-port monostatic co-channel simultaneous transmit and receive (c-STAR) spiral antenna aperture. Other examples are also provided.

### CROSS-REFERENCE TO RELATED APPLICATIONS

This application claims the benefit of U.S. provisional application No. 62/350,914, filed Jun. 16, 2016, which is hereby incorporated by reference as though fully set forth herein.

### GOVERNMENT LICENSE RIGHTS

This invention was made with government support under grant number N00014-15-1-2125 awarded by the Office of Naval Research. The government has certain rights in the invention.

### BACKGROUND

### a. Field

The present disclosure relates to a simultaneous transmit and receive aperture useful for radio frequency (RF) communications systems and electronic communications applications.

### b. Background

Simultaneous transmit and receive (STAR) systems have been seriously considered to maximize the use of the frequency spectrum. Transmitting and receiving on the same frequency at the same time lead to more efficient use of the available resources and data throughput improvement. However, there are many challenges with the STAR system design; including achieving a satisfactory isolation level. Many techniques have been proposed to overcome this challenge including, depolarized TX and RX antennas, near field cancellation at the location of the receiving antenna, ground plane modification, and the use of circulators and RF cancellation circuits to mention some. The main issues with these approaches are one or more of the: narrow bandwidth, high complexity and cost, insufficient isolation, unequal radiation characteristics, low efficiency, and large size.

### BRIEF SUMMARY

In various implementations, designs of relatively simple ultra-wideband cost effective STAR front-end systems are provided, such as implementations utilizing a plurality of antenna arms in which a first portion of the arms is configured to transmit and a second portion of the arms is configured to receive.

In one implementation, for example, a co-channel simultaneous transmit and receive (STAR) monostatic aperture configuration includes a single-polarized multi-port monostatic co-channel simultaneous transmit and receive (c-STAR) spiral antenna aperture.

In one particular implementation, for example, a STAR front-end system includes a single four-arm spiral helix aperture. A four-arm spiral antenna, for example, can be viewed as an array of two two-arm spirals. The geometrical symmetry of this array along with spiral arms orientation and the excitation of the two antennas (i.e. 180° phase difference between the opposite arms) leads to transmit (TX) leaked signal cancellation at the antenna feed resulting in a high isolation between these two spirals. The inherent wideband characteristics of this class of frequency independent antennas enable a wideband STAR performance. In some implementations, for example, isolation greater than about 80 dB can be achieved using this approach over a very wide bandwidth. To simplify the feeding network of some implementations, microstrip feeds with impedance following a Klopfenstein taper are implemented. A helix termination may also be used to improve the spirals low-end gain. In some implementations, for example, a system may have return loss of greater than 10 dB, isolation greater than about 36 dB, virtually identical RHCP radiation patterns, and a nominal gain of 4 dBic over a multi-octave bandwidth.

In another example implementation, a multiple-arm single-polarized c-STAR spiral antenna is provided. The antenna, for example, may comprise an eight-arm single-polarized c-STAR spiral antenna including two pair of four-arm spirals: four of which are transmit arms (4-TX) and four of which are receive arms (4-RX). The antenna, for example, may include two antennas spatially separated by about 45′ and still share the same aperture.

In another example implementation, an ultra-wideband dual-polarized multi-port monostatic co-channel simultaneous transmit and receive (c-STAR) aperture is provided. In this implementation, an aperture is configured such that (N/2)-arms/ports are used for transmit (TX) and (N/2)-arms/ports are used for receive (RX); where N is equal or higher than 8.

In another implementation, a dual circularly polarized c-STAR circulator in aperture is provided including even and odd non-adjacent arms grouped and adapted to be fed through a single beam-former network (BFN). On transmit, two (e.g., about 90 degree) inputs correspond to two different circularity polarity handedness. One of the groups (e.g., a four arm sinuous arrangement) is adapted to transmit while another one of the groups (e.g., another four arm sinuous arrangement) is adapted to receive.

In another implementation, an ultra-wideband multi-mode true monostatic c-STAR antenna sub-system based on a four-arm spiral aperture is provided. A single aperture having dual functionality and the same antenna-port/arm is employed. The sub-system is configured to utilize both feed self-interference cancellation and mode filtering.

In another implementation, an aperture includes a plurality of arms. Multi-mode characteristics of plurality of arms of the aperture along with applied excitation from the balanced circulator beam-former networks (BC-BFNs) enable high transmit/receive (TX/RX) isolation for diverse circular-polarization modes of radiations (i.e. broadside and split-beam modes). For example, in one particular implementation, an aperture can transmit M1 receive M1 and M2, or transmit M2 and receive M2 and M3.

In another implementation, an aperture configuration for an antenna includes a plurality of spiral arrays arranged in a generally hexagonal pattern (e.g., seven spiral arrays). In this example, sets of corresponding arm-pairs of the arrays may be arrayed into the same feed networks.

In another implementation, for example, an aperture configuration for an antenna includes a plurality of spiral arrays. The plurality of spiral arrays can be arranged in a generally octagonal pattern (e.g., eight spiral arrays). A transmit (TX)-array has a first radius different from a second radius of a receive (RX) array, and the RX-array has 0- or 45-degree rotation with respect to the TX-array.

In another implementation, a dual circularly polarized circulator in aperture transmit and receive configuration includes: even and odd non-adjacent arms grouped and fed through a single BFN. On transmit, two (e.g., about 90 degree) inputs correspond to two different circularity polarity handedness, wherein one of the groups (e.g., a four arm sinuous arrangement) is adapted to transmit while another one of the groups (e.g., another four arm sinuous arrangement) is adapted to receive.

In another implementation, an ultra-wideband multi-mode true monostatic c-STAR array sub-system is provided. The sub-system includes a single array that includes at least four antenna (e.g., spiral configuration) wherein the array is adapted to utilize feed self-interference cancellation from at least one balanced circulator beam-former network (BC-BFNs).

The foregoing and other aspects, features, details, utilities, and advantages of the present invention will be apparent from reading the following description and claims, and from reviewing the accompanying drawings.

### BRIEF DESCRIPTION OF THE DRAWINGS

FIG. 1 depicts a schematic diagram of one example implementation of a spiral-helix STAR system, according to one or more implementations described and shown herein.

FIG. 2 depicts a graph showing measured and simulated reflection coefficients of transmit and receive antennas of the system shown in FIG. 1.

FIG. 3 depicts a graph showing measured and simulated isolation response curves versus frequency between transmit (TX) and receive (RX) antennas for the system shown in FIG. 1.

FIG. 4 depicts a graph showing measured broadside axial ratio of the transmit (TX) antenna of the system shown in FIG. 1 with overlaid radiation patterns shown in an inset.

FIG. 5 depicts a schematic diagram of an example multi-arm frequency independent STAR spiral antenna, according to one or more implementations described and shown herein.

FIG. 6 depicts a schematic diagram of topologies of example frequency independent STAR spiral antennas and arrays, according to one or more implementations described and shown herein.

FIG. 7 depicts a schematic diagram of an example two-arm frequency independent STAR spiral antenna and a graph shown modeled isolation between transmit (TX) and receive (RX) arms, according to one or more implementations described and shown herein.

FIG. 8 depicts a schematic diagram of an example three-arm frequency independent STAR spiral antenna and a graph shown modeled isolation response curves versus frequency between transmit (TX) and receive (RX) arms, according to one or more implementations described and shown herein.

FIG. 9 depicts a schematic diagram of an example four-arm frequency independent STAR spiral antenna and a graph shown modeled isolation between transmit (TX) and receive (RX) arms, according to one or more implementations described and shown herein.

FIG. 10 depicts a schematic diagram of an example four-arm STAR spiral helix antenna and a graph shown measured and modeled isolation between transmit (TX) and receive (RX) arms, according to one or more implementations described and shown herein.

FIG. 11 depicts a schematic diagram of an example four-arm lens-loaded STAR spiral and a graph shown measured isolation between transmit (TX) and receive (RX) arms with and without a lens, according to one or more implementations described and shown herein.

FIG. 12 depicts a graph showing measured and simulated gains for an example four-arm lens-loaded STAR spiral far field antenna and radiation patterns for different example frequencies.

FIG. 13 depicts a schematic diagram of an example eight-arm multimode STAR spiral antenna, according to one or more implementations described and shown herein.

FIG. 14 depicts a graphs showing isolation response curves versus frequency for example eight-arm multimode lens loaded STAR antennas and radiation patterns for different example frequencies.

FIG. 15 depicts a schematic diagram of an example dual-polarized eight-arm STAR sinuous spiral antenna, according to one or more implementations described and shown herein.

FIG. 16 depicts a schematic diagram of an example N×N spiral STAR array including an example 2×2 four-arm spiral array constructed with individual four-arm unit cell STAR spiral antennas, according to one or more implementations described and shown herein.

FIG. 17 depicts graphs (a) and (b) showing isolation response curves versus frequency for broadside square and hexagonal broadside spiral STAR arrays.

### DETAILED DESCRIPTION

In various implementations, a design of relatively simple ultra-wideband cost effective STAR front-end systems are provided, such as implementations utilizing a single four-arm spiral helix aperture. A four-arm spiral antenna, for example, can be viewed as an array of two two-arm spirals. The geometrical symmetry of this array along with spiral arms orientation and the excitation of the two antennas (i.e. 180° phase difference between the opposite arms) leads to transmit (TX) leaked signal cancellation at the antenna feed resulting in a high isolation between these two spirals. The inherent wideband characteristics of this class of frequency independent antennas enable a wideband STAR performance. In some implementations, for example, isolation greater than about 80 dB can be achieved using this approach over a very wide bandwidth. To simplify the feeding network of some implementations, microstrip feeds with impedance following a Klopfenstein taper are implemented. A helix termination may also be used to improve the spirals low-end gain. In some implementations, for example, a system may have return loss of greater than about 10 dB, isolation greater than about 36 dB, virtually identical RHCP radiation patterns, and a nominal gain of 4 dBic over a multi-octave bandwidth.

In one implementation, for example, an antenna is provided including a plurality of arms arranged in a spiral configuration. At least one of the plurality of arms is configured to transmit, and at least one of the remaining plurality of arms is configured to receive.

In one particular implementation, for example, an antenna includes an eight arm spiral configuration. Four non-adjacent arms of the eight total arms are configured to transmit by being excited and the other four non-adjacent arms, each disposed between two of the four transmit arms, are configured to receive. For example, two separated four-by-four Butler matrix BFNs may be used for feeding the shared aperture between the two four-arm spirals. Isolation between the two BFNs, in some implementations, may provide at least about 20 dB of isolation.

In still further implementations, the spiral mode response with a frequency may provide a simple form transmit to receive coupling function and at least partial analog cancellation and used to further isolate the two channels.

In another implementation, a dual circularly polarized circulator in aperture transmit and receive configuration is provided. In this implementation, even and odd non-adjacent arms are grouped and fed through a single BFN, such as described above with respect to the example eight arm spiral configuration described above. On transmit, two (e.g., about 90 degree) inputs correspond to two different circularity polarity handedness. One of the groups (e.g., a four arm sinuous arrangement) is adapted to transmit while another one of the groups (e.g., another four arm sinuous arrangement) is adapted to receive. In one implementation, for example, two different waveforms may be simultaneously transmitted, such as two different waveforms having non-overlapping bandwidths.

In yet another implementation, a plurality of spiral arrays is provided and isolation may be optimized (or at least improved). In one implementation, for example, the plurality of spiral arrays is arranged in a generally hexagonal pattern (e.g., seven spiral arrays). Sets of corresponding arm-pairs of the arrays may be arrayed into the same feed networks. In one particular implementation, for example, a first plurality of arm-pairs of each of the spiral arrays (e.g., even arm-pairs) may be adapted to transmit and a second plurality of arm-pairs of each of the spiral arrays (e.g., odd arm-pairs) may be adapted to receive. In one implementation, for example, each of the first plurality of arm-pairs are fed into a first feed network and each of the second plurality of arm-pairs of each of the spiral arrays are fed into a second feed network. Scanning may be performed, for example, by phase shifting or other methodologies. In one particular implementation, for example, an outside ring is adapted to transmit and an inner ring is adapted to receive. An adaptive null steering may be applied to the receive antenna and may improve isolation during a scan.

In another implementation, RF front-ends, e.g., a Circulator In Aperture (CIA) configuration adapted to simultaneously perform EA, ES, and other functions (communications) over ultra-wide bandwidths, high power and isolation is provided. The CIA, for example, may comprise an antenna (array) with embedded transmit (TX) and receive (RX) discrimination. CIA front ends with single and dual-polarized capability, fixed and steering beams, isolation (e.g., at least about 50 dB without any DSP cancellation), ERP greater than about 1 kW and bandwidths greater than about 5:1 may be provided.

In yet another implementation, a co-channel simultaneous transmit and receive (STAR) monostatic aperture configuration, an antenna system including such an aperture, a method of designing such an aperture, a method of controlling such an aperture and/or a method of operating an antenna using such an aperture is provided including one or more of the following:
An ultra-wideband single-polarized multi-port monostatic co-channel simultaneous transmit and receive (c-STAR) spiral antenna aperture is provided. In this particular implementation, for example, the aperture may be configured in such that (N/2)-arms/ports are used for transmit (TX) and (N/2)-arms/ports are used for receive (RX). Theoretically “infinite” isolation may be achieved as long the symmetry is maintained. Various level of isolation can be achieved based on the selected number of arms. In one implementation, for example, a STAR aperture may be provided including one or more of the following:
   A four-arm single-polarized c-STAR spiral (i.e. two pair of two-arm spirals: 2-TX and 2-RX) is provided. A geometrical symmetry of the array along with spiral arm orientation and the excitation of the two antennas (e.g., 180° phase difference between the opposite arms) leads to cancel the self-interference at the RX-antenna feed resulting in a theoretically infinite isolation between these two spirals.
   An eight-arm single-polarized c-STAR spiral (i.e. two pair of four-arm spirals: 4-TX and 4-RX) is provided in another implementation. In this example, the two antennas may be spatially separated by 45° and still share the same aperture. Thus, in this implementation, the system is considered monostatic. Theoretically, infinite isolation can be achieved by utilizing the feed self-interference cancellation at the RX-feeding-port and mode filtering techniques.
   An eight-arm/port c-STAR single aperture configuration can utilize antenna diversity in another implementation. The geometrical symmetry is not mandatory between the TX and RX antennas, as well as the position of the feeding arrangement. This can be beneficial for various applications.
   Multi-mode characteristics of the eight-arm spiral aperture along with applied excitation enable high TX/RX isolation for diverse circular-polarization modes of radiation (i.e. broadside and split-beam modes). This way antenna system may be used simultaneously for transmit and determination of angle of arrival.

Although examples are described with particular numbers of “arms,” designs with other number of arms are also contemplated.

In another implementation, an ultra-wideband dual-polarized multi-port monostatic co-channel simultaneous transmit and receive (c-STAR) aperture is provided. The aperture is configured such that (N/2)-arms/ports are used for TX and (N/2)-arms/ports are used for RX; where N is equal or higher than 8. Theoretically “infinite” isolation can be achieved as long the symmetry is maintained. The aperture configuration, an antenna system including such an aperture, a method of designing such an aperture, a method of controlling such an aperture and/or a method of operating an antenna using such an aperture are provided including one or more of the following:
A dual circularly polarized c-STAR circulator in aperture. In this implementation, even and odd non-adjacent arms may be grouped and fed through a single beam-former network (BFN), such as described above with respect to the example eight arm spiral configuration. On transmit, two (e.g., about 90 degree) inputs correspond to two different circularity polarity handedness. One of the groups (e.g., a four arm sinuous arrangement) is adapted to transmit while another one of the groups (e.g., another four arm sinuous arrangement) is adapted to receive.
In one implementation, for example, two different waveforms may be simultaneously transmitted, such as two different waveforms having non-overlapping bandwidths.
An ultra-wideband multi-mode true monostatic c-STAR antenna sub-system based on four-arm spiral aperture is provided. In this configuration, the same aperture may have dual functionality and the same antenna-port/arm is employed, (i.e. less number of arms/ports compared to the above configuration).
This proposed STAR approach utilizes both feed self-interference cancellation and mode filtering techniques to achieve “theoretically” infinite isolation over wideband without any time, frequency, spatial, or polarization duplexing.

Furthermore, multi-mode characteristics of the four-arm spiral aperture along with applied excitation from the balanced circulator beam-former networks (BC-BFNs) enables high TX/RX isolation for diverse circular-polarization modes of radiations (i.e. broadside and split-beam modes). For example, the proposed approach can transmit M1 receive M1 and M2, or transmit M2 and receive M2 and M3.

### C-STAR Monostatic Array Configuration

In yet another implementation, a plurality of spiral arrays is provided and high isolation can be obtained. In one implementation, for example, the plurality of spiral arrays is arranged in a generally hexagonal pattern (e.g., seven spiral arrays). Sets of corresponding arm-pairs of the arrays may be arrayed into the same feed networks. In one particular implementation, for example, a first plurality of arm-pairs of each of the spiral arrays (e.g., even arm-pairs) may be adapted to transmit and a second plurality of arm-pairs of each of the spiral arrays (e.g., odd arm-pairs) may be adapted to receive.

For example, in some implementations each of the first plurality of arm-pairs are fed into a first feed network and each of the second plurality of arm-pairs of each of the spiral arrays are fed into a second feed network.

In some implementations, scanning may be performed, for example, by phase shifting or other methodologies. In one particular implementation, for example, an outside ring is adapted to transmit and an inner ring is adapted to receive.

An adaptive null steering may be applied to the receive antenna and may improve isolation during a scan.

A plurality of spiral arrays may be provided with “theoretically” infinite isolation. For example, the plurality of spiral arrays are arranged in a generally octagonal pattern (e.g., eight spiral arrays). The array elements arranged to have similar distance from the center. Sets of corresponding arm-pairs of the arrays may be arrayed into the same feed networks.

A plurality of spiral arrays may be provided with “theoretically” infinite isolation. For example, the plurality of spiral arrays are arranged in a generally octagonal pattern (e.g., eight spiral arrays). The TX-array has a different radius compared to the RX-array, where the RX-array has 0- or 45-degree rotation with respect to the TX-array. Sets of corresponding arm-pairs of the arrays may be arrayed into the same feed networks. For example, an outside ring is adapted to transmit and an inner ring is adapted to receive.

Higher number (>8) of antenna elements can be utilized and still possible infinite or improved isolation can be obtained as long the symmetry is maintained. The drawback is more complex, sensitive, and costly beam-feeding network.

In one implementation, a dual circularly polarized circulator in aperture transmit and receive configuration is provided. In this implementation, even and odd non-adjacent arms are grouped and fed through a single BFN such as described above with respect to the example eight arm spiral configuration described above. On transmit, two (e.g., about 90 degree) inputs correspond to two different circularity polarity handedness. One of the groups (e.g., a four arm sinuous arrangement) is adapted to transmit while another one of the groups (e.g., another four arm sinuous arrangement) is adapted to receive. In one implementation, for example, two different waveforms may be simultaneously transmitted, such as two different waveforms having non-overlapping bandwidths.

In another implementation, an ultra-wideband multi-mode true monostatic c-STAR array sub-system based on a single array that includes four or more antennas (e.g., spiral) is provided. In this configuration, the proposed STAR approach utilizes the feed self-interference cancellation from the balanced circulator beam-former networks (BC-BFNs) to enable “theoretically” infinite isolation over wideband for diverse circular-polarization modes of radiations (i.e. broadside and split-beam modes).

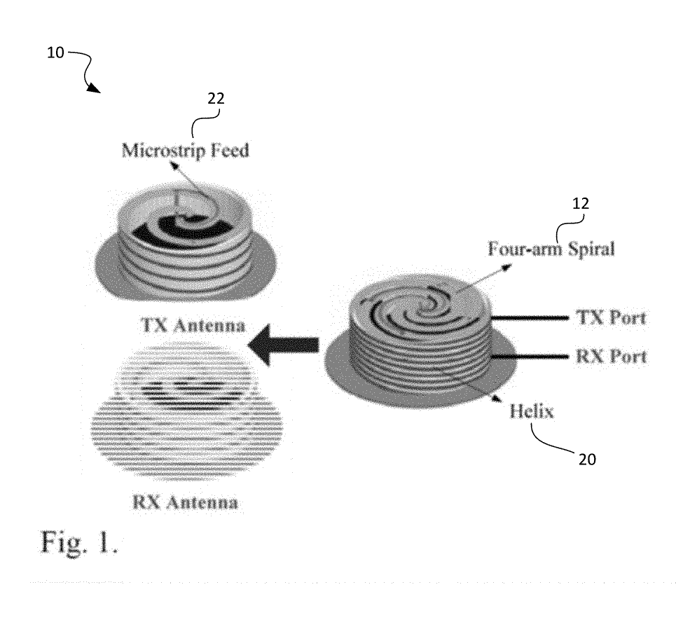

One example configuration of a STAR system 10 is shown in FIG. 1. In this example implementation, the STAR system comprises a plurality of multiple arm spirals 12 (e.g., two two-arm spirals) terminated by a helix 20 and fed by a microstrip line 22. In this implementation, the microstrip line 22 may use the spiral arm as a ground plane and perform impedance transformation and 180° phase offset between the sets of opposite arms. The microstrip ground at the taper's outside end may be used to solder a shield of a coaxial cable. For example, in one implementation, ferrite beads are placed around the coaxial feed.

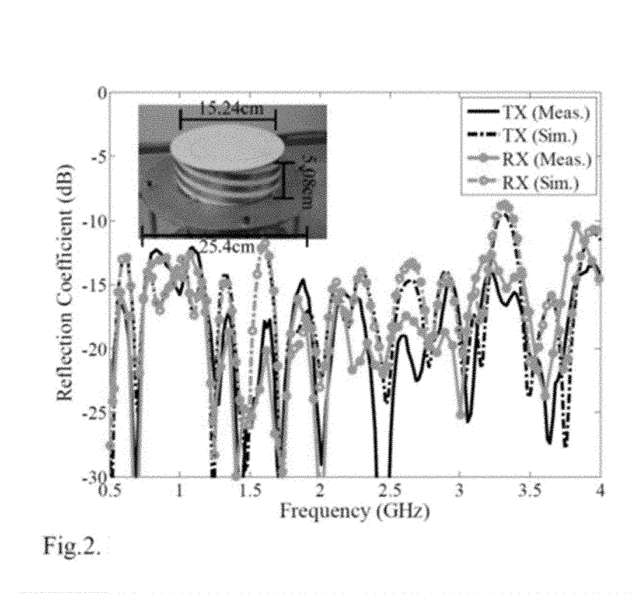

An example fabricated article implementation along with its geometrical parameters is shown in the inset of FIG. 2. The spiral aperture, in this particular implementation, is a single-turn Archimedean spiral with 5:1 metal to slot ratio (MSR). The antenna has an outer radius of 7.6 cm and inner radius of 0.2 cm and is fabricated on a 0.508 mm thick Rogers RO3003 substrate (Σᵣ=3, tan δ=0.0013). An example self-complementary quadrifilar helix termination may have 0.75-turns and height of about 5.08 cm and is electroplated on a hollow Teflon cylinder. In this implementation, to provide a good impedance match over a desired bandwidth of operation, a lumped resistive loading may be implemented between the bottom arm ends of the helix and the ground plane. In addition to improving the impedance match and low-end gain, employing the helix and the resistive termination helps to maintain good and consistent isolation by eliminating the reflected currents from the spiral's arms.

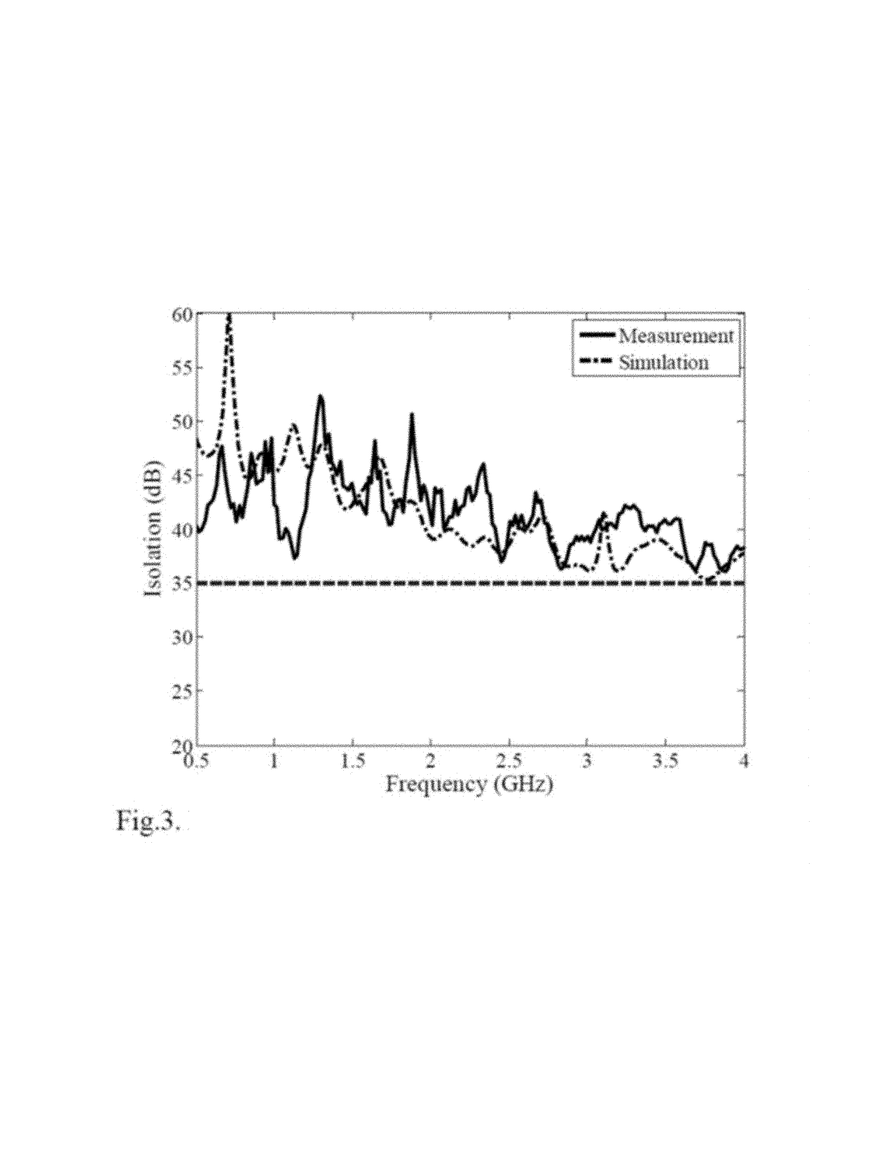

Measured reflection coefficients of transmit (TX) and receive (RX) antennas are shown in FIG. 2. As shown in FIG. 2, good impedance match may be obtained over an 8:1 bandwidth. However, in this particular example, the high-end far-field performance of the antenna is limited by the height over the ground plane Similar performances may be measured for both antennas (TX and RX). The measured isolation of greater than 36 dB is obtained over the operating bandwidth with a nominal value of 40 dB, as seen in FIG. 3. Notice that the measurement was conducted in an open laboratory environment where different scatters surround the antenna. No time gating is applied. The isolation is also tested with different scattering objects nearby the antenna and no adverse effect is observed.

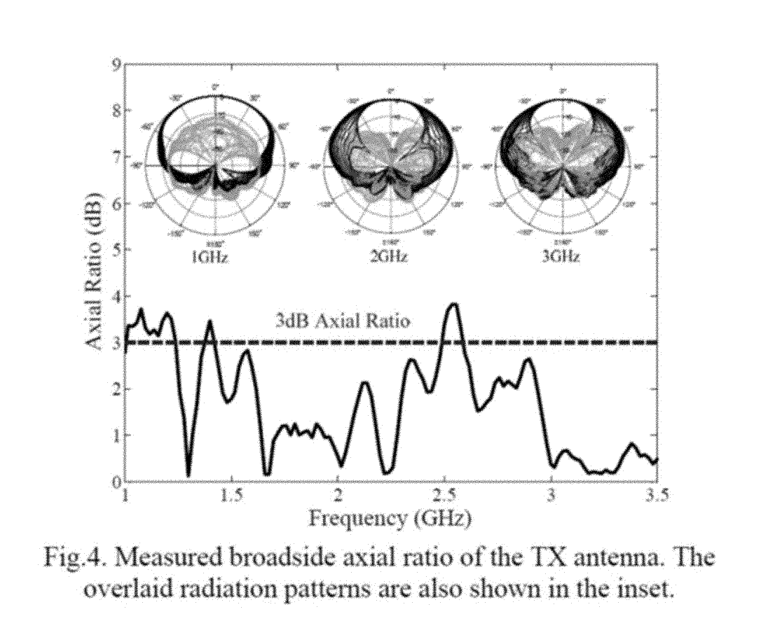

The far-field performances of the transmit (TX)/receive (RX) antennas are also characterized. The measured broadside axial ratio, in this example, (less than 3 dB over most of the bandwidth) of the transmit (TX) antenna is shown in FIG. 4. The measured radiation patterns overlaid for 61 azimuthal cuts from 0° to 180° are shown in the inset of FIG. 4 for 1 GHz, 2 GHz and 3 GHz. As seen, symmetric patterns with low azimuthal gain variation up to 0=30° are obtained. Similar performance is measured for the receive (RX) antenna.

In various implementations, simple, cost-effective, wideband STAR antenna systems, such as some having measured high isolation between the transmit (TX) and receive (RX) antennas over multi-octave bandwidth are presented. Good quality and almost identical radiations characteristics may also be obtained.

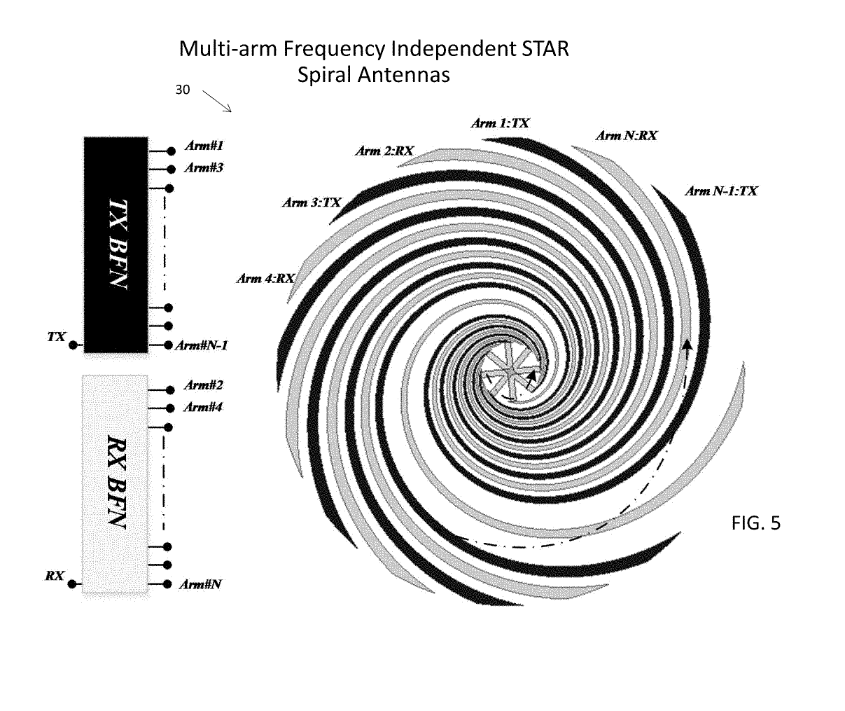

FIG. 5 shows a schematic diagram of another example implementation of a multi-arm STAR spiral antenna 30. In this particular implementation, for example, the multi-arm STAR spiral antenna 30 may comprise a frequency independent antenna. The antenna 30 comprises a plurality of receive arms RX Arm (e.g., N/2 receive arms 2, 4, . . . , N) and a plurality of transmit arms TX Arm (e.g., N/2 transmit arms, 1, 3, . . . , N−1) disposed in a spiral configuration. A transmit beam former network TX BFN receives a transmit signal at a transmit port TX and includes a plurality of output ports coupled to each of the plurality of transmit arms TX Arm. Similarly, a receive beam former network RX BFN includes a plurality of input ports coupled to each of the receive arms RX Arm and a receive output port RX for providing a received signal.

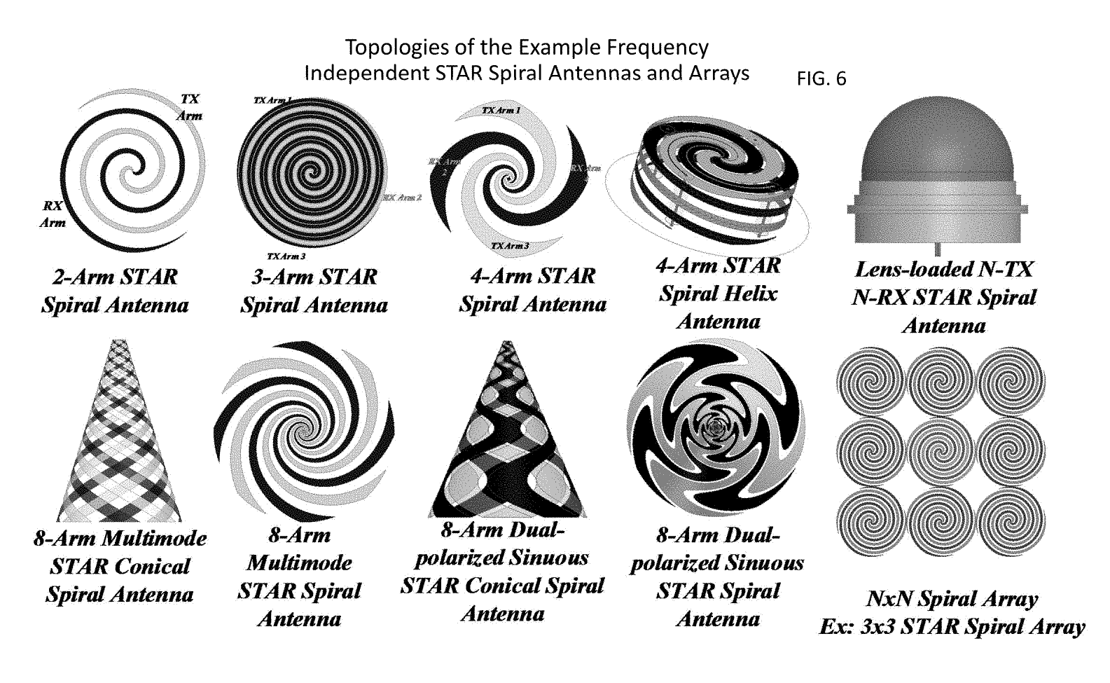

FIG. 6 shows schematic representations of example frequency independent STAR spiral antennas and arrays. In FIG. 6, for example, one example implementation includes a two-arm (TX, RX) spiral antenna. A first arm of the antenna provides a transmit arm TX, and a second arm provides a receive arm RX. A three-arm STAR spiral antenna, in this implementation, comprises two transmit arms TX Arm1 and TX Arm 3, and one receive arm RX Arm 2 disposed between the two transmit arms TX Arm 1 and TX Arm 3. A three-arm STAR spiral antenna, however, may also have a single transmit arm and two receive arms. A four-Arm Star spiral antenna similarly provides two transmit arms TX Arm 1 and TX Arm 3 and two receive arms RX Arm 2 and RX Arm 4.

FIG. 6 also shows an example four-arm STAR spiral helix antenna similarly showing two transmit arms and two receive arms.

A lens-loaded N-TX transmit arm and N-RX receive arm STAR spiral antenna is also shown in FIG. 6.

FIG. 6 also shows an eight-arm multimode STAR conical spiral antenna, an eight-arm multimode STAR spiral antenna, an eight-arm dual polarized sinuous STAR conical spiral antenna, and an eight-arm dual-polarized sinuous STAR spiral antenna.

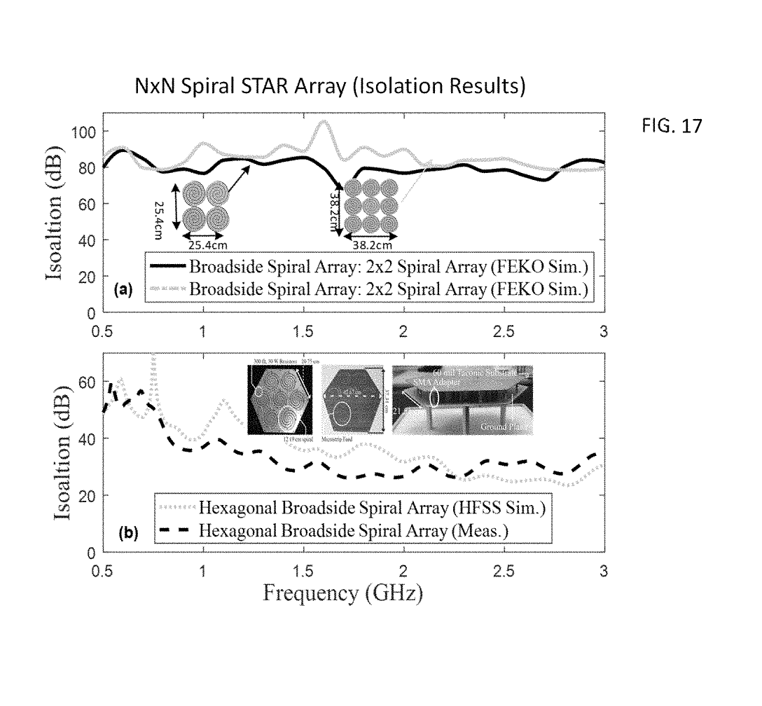

FIG. 6 also shows N×N and N×M spiral arrays of individual STAR spiral antennas. In the particular example in FIG. 6, for example, a 3×3 STAR spiral arrays are shown. Similarly, however, such an array may also include an N×M of conventional or STAR spiral antennas where each receive RX antenna element needs to see similar surrounding transmit TX elements in order for the self-interference to be fully cancelled. For example, hexagonal or circular arrays of transmit TX elements surrounding a central receive RX element (or vice versa) can be used, as shown in graph (b) of FIG. 17. Also, any of the other antennas, such as but not limited to, those designs shown in FIG. 6 may be arranged in an array of antennas.

The configurations shown in FIG. 6 are merely example antenna configurations and any other number of combinations is contemplated.

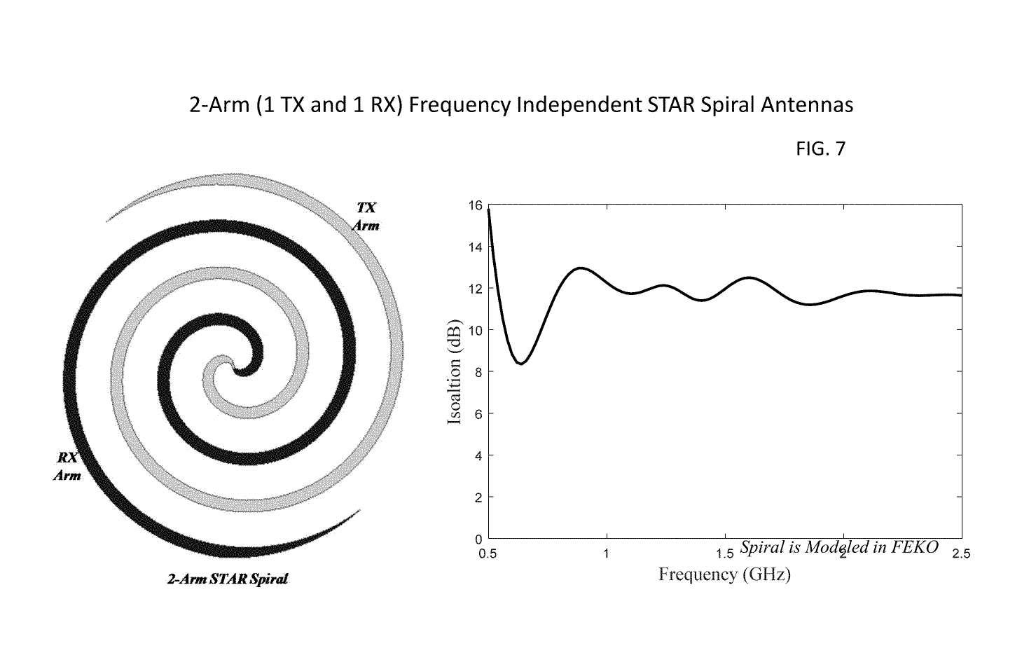

FIG. 7 shows an example implementation of a two-arm STAR spiral antenna including one transmit arm TX and one receive arm RX. FIG. 7 further depicts a graph showing a modeled isolation between the transmit and receive arms over a signal frequency.

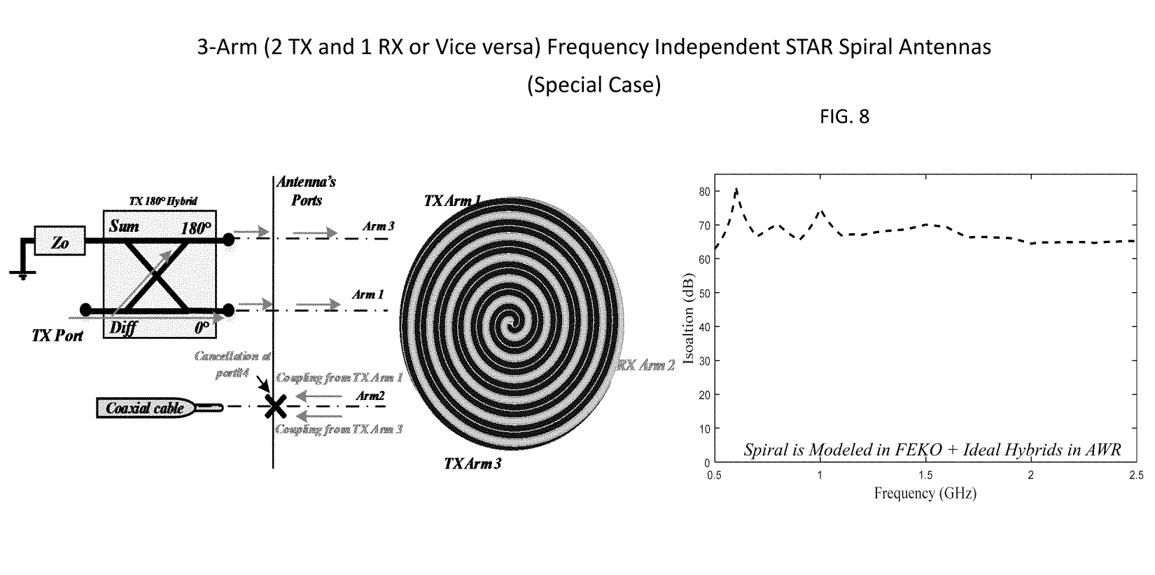

FIG. 8 shows a schematic diagram of an example implementation of a three-arm STAR spiral antenna in which two transmit arms TX Arm1 and TX Arm 3 and a single receive arm RX Arm 2 are provided in which the receive arm is generally disposed intermediate the two transmit arms. A geometrical symmetry of the spiral arms along with spiral arm orientation and the excitation of the two transmit TX arms (e.g., 180° phase difference between the opposite arms which can be excited either by a 180° hybrid or balun) leads to cancel the self-interference at the receive RX-antenna port resulting in a theoretically infinite isolation between these two-arm TX and one-arm RX spirals. FIG. 8 also depicts a graph showing a modeled isolation between the transmit and receive arms over the operating frequency band of the antenna design shown in FIG. 8.

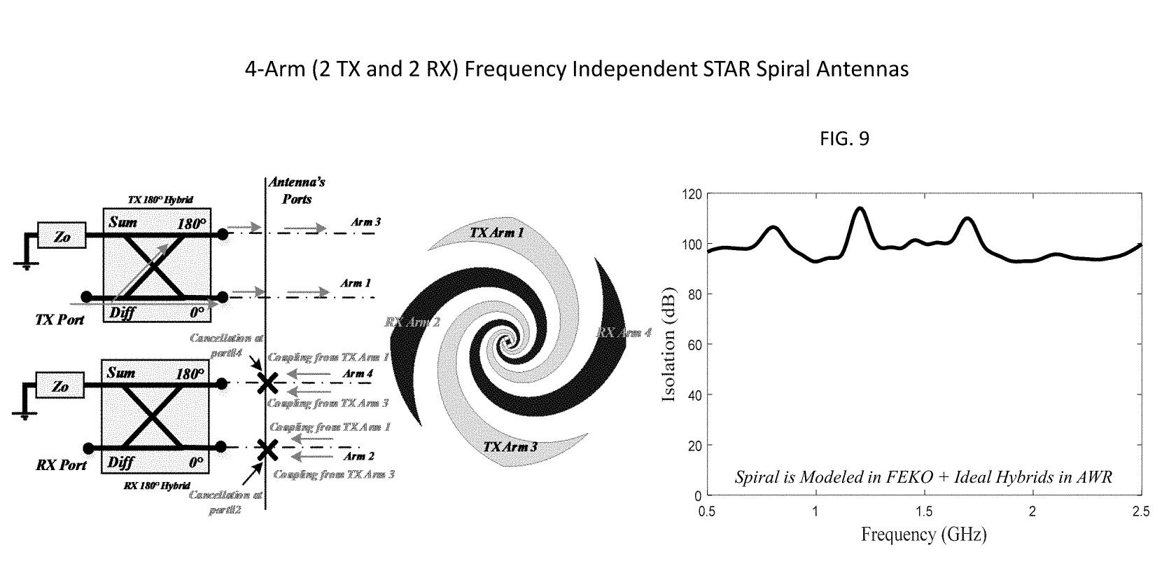

FIG. 9 shows a schematic diagram of an example implementation of a four-arm STAR spiral antenna in which two transmit arms TX Arm1 and TX Arm 3 and a two receive arms RX Arm 2 and RX Arm 4 are provided in which the receive arms are generally disposed intermediate the two transmit arms. FIG. 9 also depicts a graph showing a modeled isolation between transmit and receive arms over the operating frequency band of the antenna design shown in FIG. 9. In this example, the two-TX arms and two-RX arms are excited with 180° phase difference between the opposite arms which can be done by using 180° hybrids, balun, or microstrip/stripline feeds. This geometrical symmetry of the spiral arms, along with spiral arm orientation, and the specific excitation all lead to full cancellation of the self-interference at the RX-antenna port resulting in a theoretically infinite isolation between TX and RX spirals.

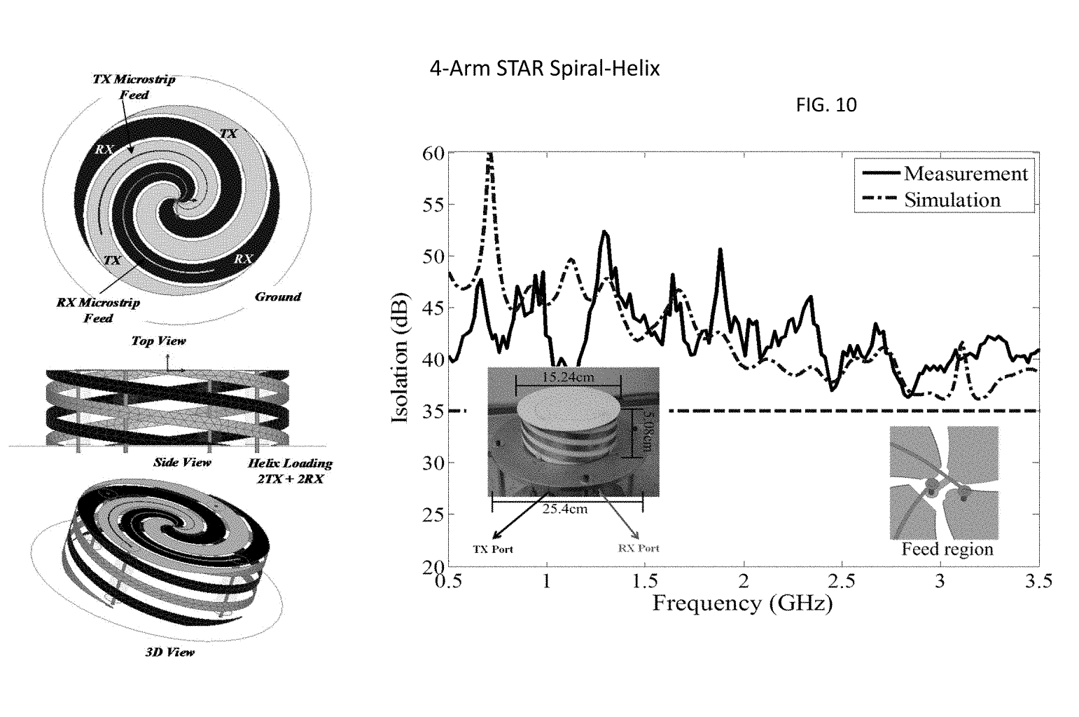

FIG. 10 shows schematic diagrams of an example implementation of a four-arm STAR spiral helix antenna. In this particular implementation, for example, the four-arm STAR spiral helix antenna includes a transmit microstrip feed, a receive microstrip feed and a ground. The two transmit arms and two receive arms are arranged in a helical loading configuration as shown in FIG. 10. FIG. 10 also depicts a graph showing a modeled isolation between the transmit and receive arms over a signal frequency for the antenna design shown in FIG. 10.

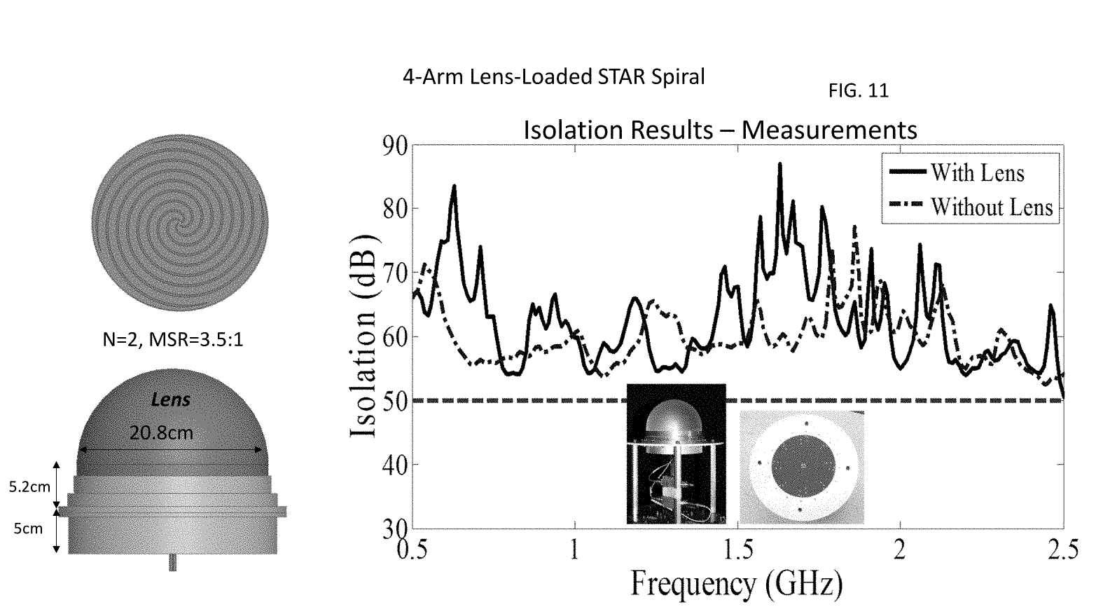

FIG. 11 shows schematic diagrams of an example implementation of a four-arm lens-loaded STAR spiral antenna. In this particular implementation, for example, the four-arm lens-loaded STAR spiral antenna includes a transmit microstrip feed, a receive microstrip feed and a ground. The two transmit arms and two receive arms are arranged in a helical loading configuration as shown in FIG. 10. FIG. 10 also depicts a graph showing a modeled frequency dependent isolation between transmit and receive arms over a signal frequency for both an antenna with the lens shown in FIG. 11 and without the lens. The lens is utilized in this configuration to decrease the negative impact of the shallow-cavity and the parasitic arms (RX arms act as parasitic to TX arms) leading to further improvement in the isolation and far-field performance.

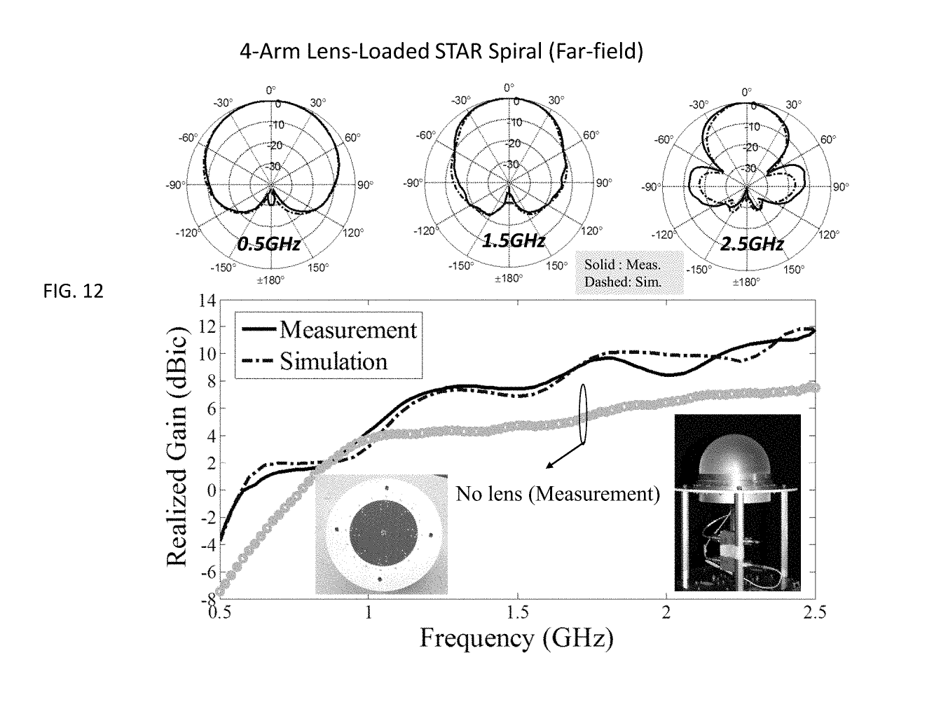

FIG. 12 shows the measured and simulated co-polarized broadside realized gains of the STAR spiral with and without lens. Realized gain >3 dBic (max. of 12 dBic) is measured between 1-2.5 GHz. TX and RX radiation patterns are similar (only TX is shown), and good agreement is observed between the measurements and simulation.

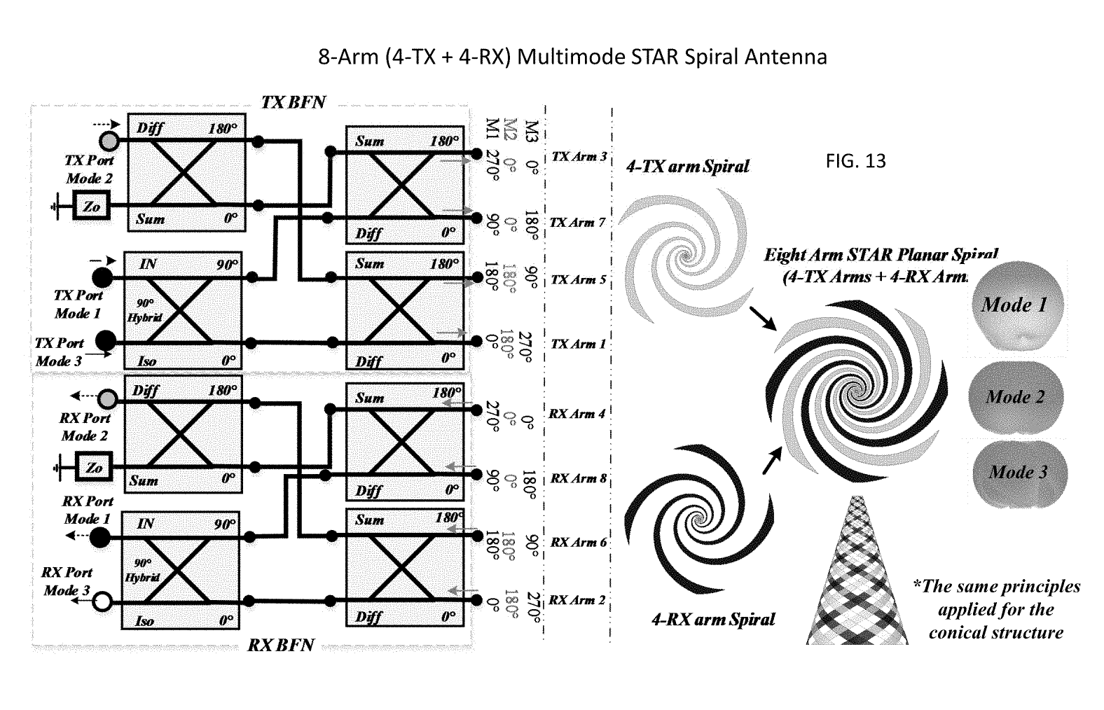

FIG. 13 shows a schematic diagram of an example implementation of an eight-arm multimode STAR spiral antenna. In this particular implementation, for example, the eight-arm STAR spiral antenna includes four spiral transmit arms and four spiral receive arms. FIG. 13 further shows transmit and receive beam former networks; TX 4×4 Butler matrix BFN (composed of three 180° and one 90° hybrids) and RX 4×4 Butler matrix BFN, respectively. The eight-arm spiral approach compared to the four-arm counterpart has an advantage of multi-mode capability enabling the system to radiate broadside and conical patterns based on the excited mode while maintaining high TX/RX isolation. The modes are: mode 1 (broadside mode), mode 2, and mode 3 (split-beam modes) which can be excited either in transmitting or receiving mode of operation. Although FIG. 13 shows a spiral antenna structure, the same principles apply for a conical structure such as shown in FIG. 6.

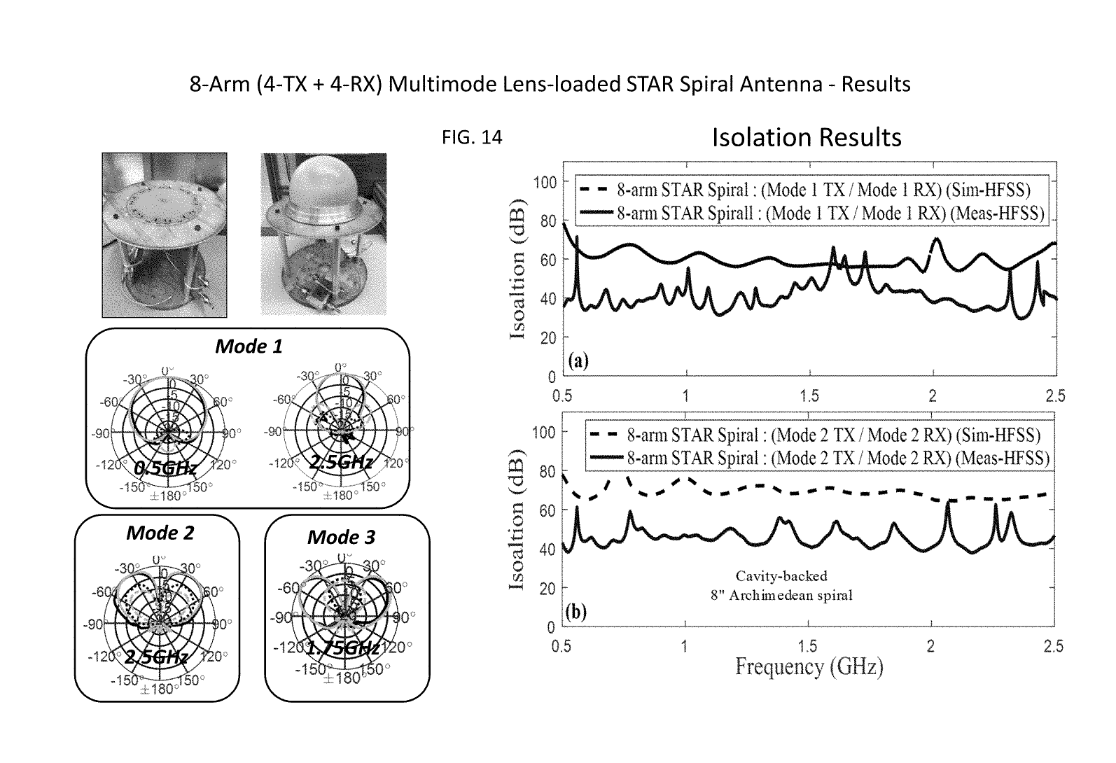

FIG. 14 shows graphical representations of a far-field response of three modes of an eight arm multimode lens-loaded STAR spiral antenna in which the antenna includes four transmit arms and four receive arms. FIG. 14 further shows sample of simulated and measured TX or RX radiated modes based on the driven ports in the TX or RX BFN. Mode 1 has broadside beam while modes 2 and 3 have split-beam shape.

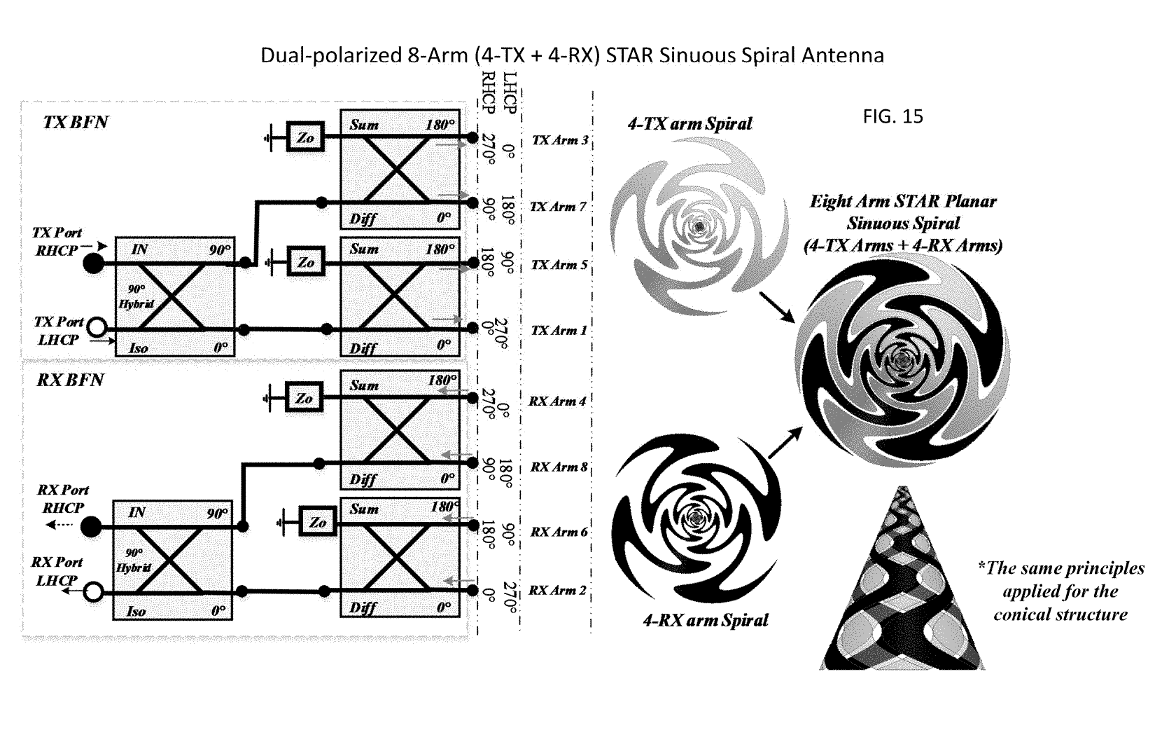

FIG. 15 shows a schematic diagram of an example implementation of a dual-polarized eight-arm STAR sinuous antenna. In this particular implementation, for example, the eight-arm STAR sinuous antenna includes four transmit arms and four receive arms. FIG. 15 further shows transmit and receive beam former networks TX BFN (composed of two 180° and one 90° hybrids) and RX BFN, respectively. In this particular implementation, for example, the antenna operates in dual-polarization modes (right-handed (RHCP) or left-handed (LHCP) circular polarization) where the desired polarization is chosen based on the excitation of one of the two ports of the TX or RX BFN's 90° hybrids. Although FIG. 15 shows a spiral antenna structure, the same principles apply for N×N arms (e.g., 8×8, 16×16, etc.) and a conical structure as well such as shown in FIG. 6.

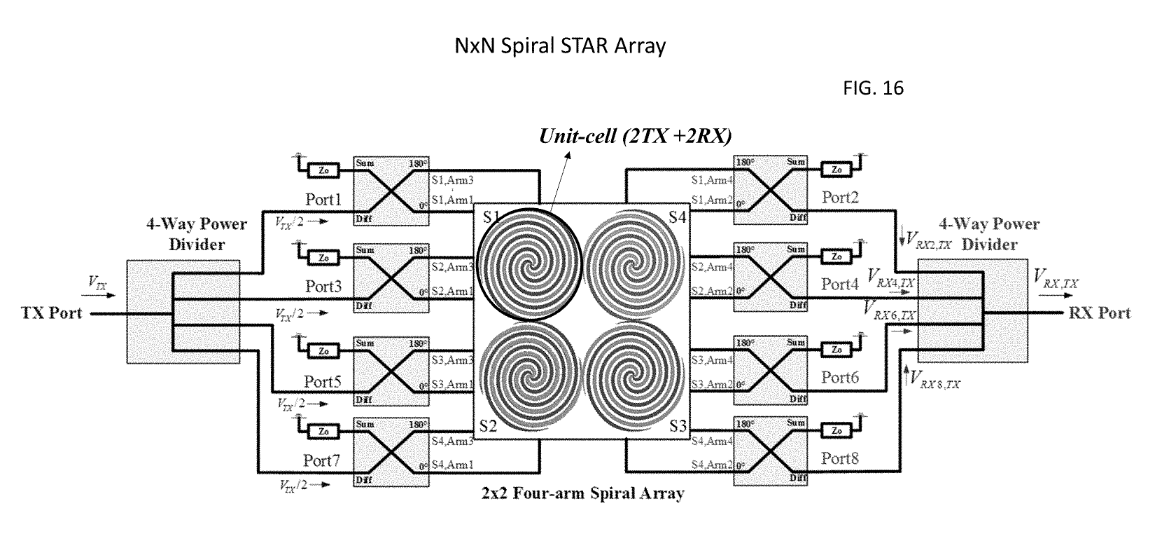

FIG. 16 shows a schematic diagram of an example implementation of N×N spiral STAR array. In this particular implementation, for example, the STAR array comprises a 2×2 array of individual four-arm STAR spiral antenna unit cells each having two transmit arms TX and two receive arms RX. Eight 180° hybrids are used to feed the TX/RX two-arm spirals array as shown in FIG. 16. Two 4-way power dividers are used to combine the inputs and outputs of TX and RX hybrids. The geometrical symmetry of a four-arm STAR spiral and feeding arrangement permit the coupled TX signal to be cancelled at the receiving path; thus enabling theoretically infinite isolation between the collocated TX and RX spirals. Another example is to have a central RX element surrounded by a ring or hexagonal TX array as shown in graph (b) of FIG. 17.

FIG. 17 depicts graphs showing isolation response curves versus frequency for broadside square and hexagonal broadside spiral STAR arrays. In addition to a 2×2 array, a 3×3 spiral array is also modeled to show the effect of the number of elements. The computed isolation is shown in graph (a) of FIG. 17. High isolation level (>70 dB) is obtained for both arrays. The number of elements is irrelevant to STAR operation as long as the geometrical symmetry is maintained. For the hexagonal STAR array (without any optimization), isolation is >23 dB over the entire array bandwidth.

Although implementations have been described above with a certain degree of particularity, those skilled in the art could make numerous alterations to the disclosed embodiments without departing from the spirit or scope of this invention. All directional references (e.g., upper, lower, upward, downward, left, right, leftward, rightward, top, bottom, above, below, vertical, horizontal, clockwise, and counterclockwise) are only used for identification purposes to aid the reader's understanding of the present invention, and do not create limitations, particularly as to the position, orientation, or use of the invention. Joinder references (e.g., attached, coupled, connected, and the like) are to be construed broadly and may include intermediate members between a connection of elements and relative movement between elements. As such, joinder references do not necessarily infer that two elements are directly connected and in fixed relation to each other. It is intended that all matter contained in the above description or shown in the accompanying drawings shall be interpreted as illustrative only and not limiting. Changes in detail or structure may be made without departing from the spirit of the invention as defined in the appended claims.

What is claimed is:

1. A co-channel simultaneous transmit and receive (STAR) monostatic aperture configuration comprising: a single-polarized multi-port monostatic co-channel simultaneous transmit and receive (c-STAR) spiral antenna aperture.

2. The monostatic aperture configuration of claim 1 wherein the monostatic aperture is configured such that (N/2)-arms/ports are used for transmit (TX) and (N/2)-arms/ports are used for receive (RX).

3. The monostatic aperture configuration of claim 1 wherein the monostatic aperture comprises a four-arm single-polarized c-STAR spiral having two pair of two-arm spirals, a first pair for transmit TX and a second pair for receive RX, wherein a geometrical symmetry of the array along with spiral arm orientation and the excitation of the two antennas (e.g., 180° phase difference between the opposite arms) are adapted to cancel at least a portion of self-interference at an RX-antenna feed.

4. The monostatic aperture configuration of claim 1 wherein an eight-arm single-polarized c-STAR spiral comprises two pair of four-arm spirals: 4-TX and 4-RX, wherein the two antennas are spatially separated by about 45° and share the same aperture.

5. An eight-arm/port c-STAR single aperture configuration comprising: multi-mode characteristics of an eight-arm spiral aperture along with an applied excitation enabled high TX/RX isolation for diverse circular-polarization modes of radiation (i.e. broadside and split-beam modes).

6. The aperture configuration of claim 5 wherein an antenna system utilizing the aperture configuration is used simultaneously for transmit and determination of angle of arrival.

7. An ultra-wideband dual-polarized multi-port monostatic co-channel simultaneous transmit and receive (c-STAR) aperture comprising: an aperture configured such that (N/2)-arms/ports are used for TX and (N/2)-arms/ports are used for RX; where N is equal or higher than 8.

8. A dual circularly polarized c-STAR circulator in aperture comprising: even and odd non-adjacent arms grouped and adapted to be fed through a single beam-former network (BFN): on transmit, two inputs correspond to two different circularity polarity handedness; one of the groups is adapted to transmit while another one of the groups is adapted to receive.

9. The aperture of claim 8 wherein two different waveforms may be simultaneously transmitted.

10. An ultra-wideband multi-mode true monostatic c-STAR antenna sub-system based on a four-arm spiral aperture comprising: a single aperture having dual functionality and the same antenna-port/arm is employed, wherein the sub-system is configured to utilize both feed self-interference cancellation and mode filtering.

11. The subsystem of claim 10 wherein the cancellation and mode filtering are configured to achieve theoretically infinite isolation over wideband without any time, frequency, spatial, or polarization duplexing.

12. An aperture comprising a plurality of arms wherein multi-mode characteristics of plurality of arms of the aperture along with applied excitation from the balanced circulator beam-former networks (BC-BFNs) enables high TX/RX isolation for diverse circular-polarization modes of radiations.

13. An aperture configuration for an antenna comprising a plurality of spiral arrays arranged in a generally hexagonal pattern (e.g., seven spiral arrays), wherein sets of corresponding arm-pairs of the arrays may be arrayed into the same feed networks.

14. The aperture configuration of claim 13 wherein a first plurality of arm-pairs of each of the spiral arrays may be adapted to transmit and a second plurality of arm-pairs of each of the spiral arrays may be adapted to receive.

15. The aperture configuration of claim 14 wherein each of the first plurality of arm-pairs are fed into a first feed network and each of the second plurality of arm-pairs of each of the spiral arrays are fed into a second feed network.

16. The aperture configuration of claim 13 wherein the aperture configuration is configured such that scanning is performed, such as by phase shifting or other methodologies.

17. The aperture configuration claim 16 wherein an outside ring is adapted to transmit and an inner ring is adapted to receive.

18. The aperture configuration of claim 13 wherein an adaptive null steering is applied to the receive antenna to improve isolation during a scan.

19. The aperture configuration of claim 13 wherein the plurality of spiral arrays are arranged in a generally octagonal pattern.

20. The aperture configuration of claim 19 wherein the plurality of spiral arrays are arranged to have similar distance from a center, optionally wherein sets of corresponding arm-pairs of the arrays are arrayed into the same feed networks.

21. An aperture configuration for an antenna comprising plurality of spiral arrays wherein the plurality of spiral arrays are arranged in a generally octagonal pattern, a transmit (TX)-array has a first radius different from a second radius of a receive (RX) array, where the RX-array has 0- or 45-degree rotation with respect to the TX-array.

22. The aperture configuration of claim 21 wherein sets of corresponding arm-pairs of the arrays are arrayed into the same feed networks, optionally wherein an outside ring is adapted to transmit and an inner ring is adapted to receive.

23. A dual circularly polarized circulator in aperture transmit and receive configuration comprising: even and odd non-adjacent arms grouped and fed through a single BFN: on transmit, two inputs correspond to two different circularity polarity handedness, wherein one of the groups is adapted to transmit while another one of the groups is adapted to receive.

24. The aperture of claim 23 wherein the aperture is configured such that two different waveforms may be simultaneously transmitted.

25. An ultra-wideband multi-mode true monostatic c-STAR array sub-system comprising a single array that includes at least four antenna wherein the array is adapted to utilize feed self-interference cancellation from at least one balanced circulator beam-former network (BC-BFNs).

26. The sub-system of claim 25 wherein the network is adapted to enable a “theoretically” infinite isolation over wideband for diverse circular-polarization modes of radiations.
